(19) United States
(12) Patent Application Publication
(10) Pub. No.: US 2017/0221241 A1
(43) Pub. Date: Aug. 3, 2017

(54) SYSTEM, METHOD AND APPARATUS FOR GENERATING BUILDING MAPS

(71) Applicant: 8681384 Canada Inc., Toronto (CA)

(72) Inventor: Ian HANNAH, Toronto (CA)

(21) Appl. No.: 15/009,212

(22) Filed: Jan. 28, 2016

(51) Int. Cl. G06T 11/60; G06K 9/00; B64C 11/00; B64D 47/08; B64C 39/02

(52) U.S. Cl. CPC G06T 11/60; B64D 47/08; B64C 39/024; B64C 11/00; G06K 9/00637; B64C 2201/127; B64C 2201/042; B64C 2201/165

(57) ABSTRACT

A system for generating a map for a building includes an unmanned aerial vehicle carrying at least one imaging device; and a computing device connected to the unmanned aerial vehicle. The computing device obtains building parameters defining a portion of the building to be mapped according to a frame of reference; obtains flight parameters defining a flight path for the unmanned aerial vehicle; obtains imaging parameters defining a plurality of image capture operations for the imaging device of the unmanned aerial vehicle; and deploys the flight path parameters and the imaging parameters to the unmanned aerial vehicle. The computing device receives a plurality of images captured by the unmanned aerial vehicle according to the imaging parameters; generates a composite image from the plurality of images; and stores the composite image in a memory.

### FIELD

The specification relates generally to building surveys, and specifically to a system, method and apparatus for generating building maps.

### BACKGROUND

Building envelope structures, responsible for maintaining the internal environment of the building in the face of varying external conditions, are subject to a variety of environmental conditions including widely ranging temperatures, moisture, winds and the like. As a result, building envelopes may develop defects that reduce the effectiveness of the envelopes, for example allowing heat to escape the building and moisture to enter the building. Such defects may not be readily visible, and additionally can be in areas that are difficult or dangerous to access, such as on the roof of a building. Therefore, identifying such defects can require costly and dangerous investigations, supported by various specialized equipment.

### SUMMARY

According to an aspect of the specification, a system is provided for generating a map for a building, comprising: an unmanned aerial vehicle carrying at least one imaging device; a computing device connected to the unmanned aerial vehicle, the computing device configured to: obtain building parameters defining a portion of the building to be mapped according to a frame of reference; obtain flight parameters defining a flight path for the unmanned aerial vehicle; obtain imaging parameters defining a plurality of image capture operations for the imaging device of the unmanned aerial vehicle; deploy the flight path parameters and the imaging parameters to the unmanned aerial vehicle; responsive to deploying the flight path parameters and the imaging parameters, receive a plurality of images from the unmanned aerial vehicle, the plurality of images captured by the unmanned aerial vehicle according to the imaging parameters; generate a composite image from the plurality of images; and store the composite image in a memory.

### BRIEF DESCRIPTIONS OF THE DRAWINGS

Embodiments are described with reference to the following figures, in which:

FIG. 1 depicts a system for generating building maps, according to a non-limiting embodiment;

FIG. 2 depicts certain internal components of the vehicle and computing device of FIG. 1, according to a non-limiting embodiment;

FIG. 3 depicts a method of generating building maps, according to a non-limiting embodiment;

FIG. 4 depicts a flight path generated through the performance of the method of FIG. 3, according to a non-limiting embodiment;

FIG. 5A depicts a pair of images received during the performance of the method of FIG. 3, according to a non-limiting embodiment;

FIG. 5B depicts a composite image generated from the images of FIG. 5A, according to a non-limiting embodiment; and

FIG. 6 depicts a system for generating building maps, according to another non-limiting embodiment.

### DETAILED DESCRIPTION OF THE EMBODIMENTS

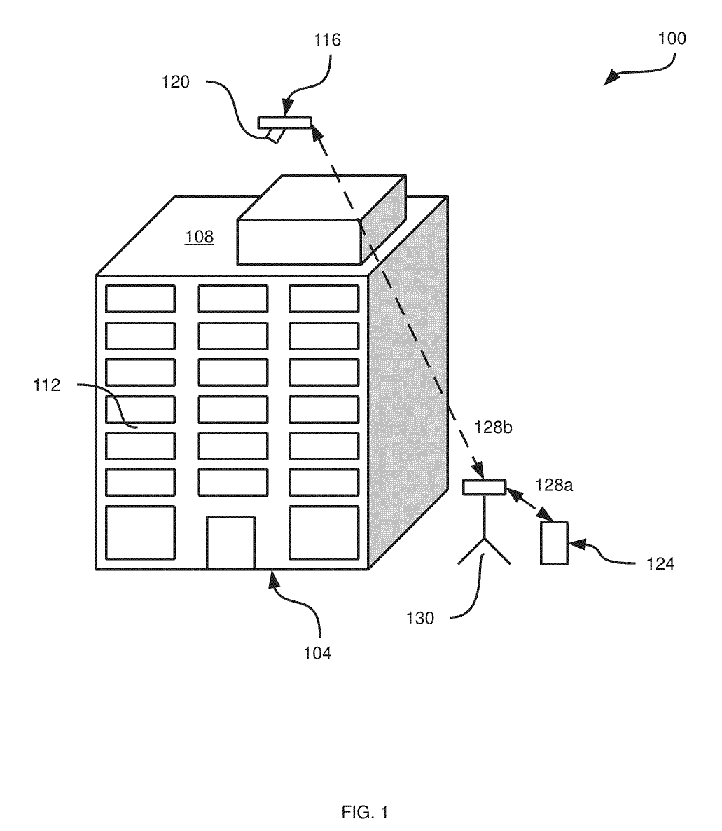

FIG. 1 depicts a system 100 for generating building maps. In the present embodiment, system 100 is deployed to generate one or more maps of the exterior surface (or at least a portion thereof) of a building 104. The exterior surface of building 100 includes a roof 108 (shown in FIG. 1 as having surfaces at two different elevations) and a plurality of walls 112. System 100 can also be deployed to generate maps of buildings other than building 104.

System 100 includes an unmanned aerial vehicle 116 carrying at least one imaging device 120, as will be discussed in further detail below. System 100 also includes a computing device 124 connected to unmanned aerial vehicle 116 via a communications link 128. In the present embodiment, communications link is implemented as two links; a first link 128a from computing device 124 to a repeater 130, and a second link 128b from repeater 130 to vehicle 116. In other embodiments, repeater 130 may be omitted and computing device 124 can connect directly to vehicle 116. Computing device 124 is a mobile computing device such as a laptop computer or tablet computer in the present embodiment; however, in other embodiments, computing device 128 can be implemented as any other suitable computing device, including a smart phone, a desktop computer, or the like. In the present embodiment, links 128a and 128b are illustrated as direct, local communications links (e.g. Bluetooth). In other embodiments, however, links 128 can traverse one or more networks (not shown), including both local (e.g. local wireless area networks or WLANs) and wide area networks (e.g. cellular networks and the like).

In general, computing device 124 is configured to obtain and deploy control parameters to unmanned aerial vehicle 116. Unmanned aerial vehicle 116, in response, is configured to traverse one or more surfaces of building 104 and capture a plurality of images of the traversed surface using imaging device 120, according to the control parameters received from computing device 124. Computing device 124 is then configured to receive the above-mentioned plurality of images and to generate a composite image depicting the relevant surface (or surfaces) of building 104.

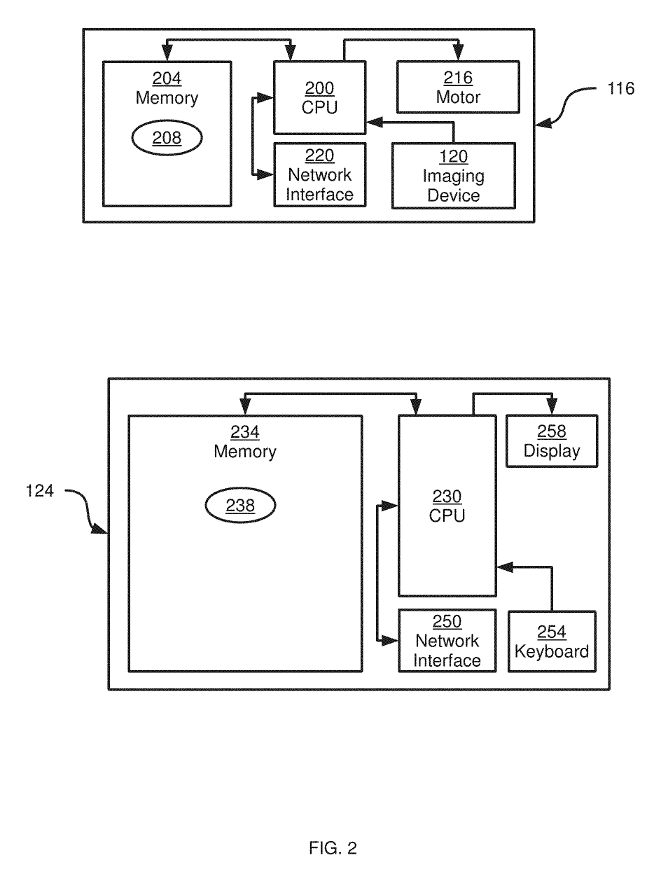

Before a detailed discussion of the operation of system 100 is provided, certain components of unmanned aerial vehicle 116 and computing device 124 will be described with reference to FIG. 2.

Referring now to FIG. 2, unmanned aerial vehicle 116 includes a central processing unit (CPU) 200, also referred to herein as processor 200, interconnected with a memory 204. Memory 204 stores computer readable instructions executable by processor 200, including a data capture application 208. Processor 200 and memory 204 are generally comprised of one or more integrated circuits (ICs), and can have a variety of structures, as will now occur to those skilled in the art. Processor 200 executes the instructions of application 208 to perform, in conjunction with the other components of unmanned aerial vehicle 116, various functions related to travelling along a predetermined flight path and capturing images at certain specified locations, times or the like. In the below discussion of those functions, unmanned aerial vehicle 116 is said to be configured to perform those functions—it will be understood that unmanned aerial vehicle 116 is so configured via the processing of the instructions in application 208 by the hardware components of unmanned aerial vehicle 116 (including processor 200 and memory 204).

Unmanned aerial vehicle 116 also includes, as illustrated in FIG. 1, imaging device 120 interconnected with processor 200. Imaging device 120 can include any one of, or any suitable combination of, an optical camera (that is, a camera configured to capture visible light), an infrared or near-infrared camera, a lidar sensor and the like. Unmanned aerial vehicle 116 can also include other input devices (not shown), such as any one of, or any suitable combination of, non-optical distance sensors (e.g. an ultrasonic sensor), a microphone, a GPS receiver, and the like. Unmanned aerial vehicle 116 also includes a network interface 220 interconnected with processor 200, which allows unmanned aerial vehicle 116 to connect to computing device 124 (e.g. via link 128). Network interface 220 thus includes the necessary hardware, such as radio transmitter/receiver units, network interface controllers and the like, to communicate over link 128.

Unmanned aerial vehicle 116 includes additional components (not shown), including at least one locomotive device such as a propeller, driven by at least one motor. The at least one motor, as well as the components of unmanned aerial vehicle 116 shown in FIG. 2, are supplied with power from a battery or other power source (e.g. a solar panel in combination with the battery) housed within unmanned aerial vehicle 116. Processor 200 is connected to the locomotive devices and motors of unmanned aerial vehicle 116 to control the movements of unmanned aerial vehicle 116.

Computing device 124 includes a central processing unit (CPU) 230, also referred to herein as processor 230, interconnected with a memory 234. Memory 234 stores computer readable instructions executable by processor 230, including a control application 238. Processor 230 and memory 234 are generally comprised of one or more integrated circuits (ICs), and can have a variety of structures, as will now occur to those skilled in the art (for example, more than one CPU can be provided). Processor 230 executes the instructions of application 238 to perform, in conjunction with the other components of application server 116, various functions related to deploying flight and imaging parameters to unmanned aerial vehicle 116, receiving image data from unmanned aerial vehicle 116 and generating a map in the form of a composite image. In the discussion below of those functions, computing device 124 is said to be configured to perform those functions—it will be understood that computing device 124 is so configured via the processing of the instructions in application 238 by the hardware components of computing device 124 (including processor 230 and memory 234).

Computing device also includes a network interface 250 interconnected with processor 230, which allows computing device 124 to connect to unmanned aerial vehicle 116 via link 128 or any other suitable communications link (e.g. via one or more networks). Network interface 250 thus includes the necessary hardware, such as network interface controllers and the like, to communicate over link 128. Computing device 124 also includes input devices interconnected with processor 230, such as a keyboard 254, as well as output devices interconnected with processor 230, such as a display 258. Other input and output devices (e.g. a mouse, speakers) can also be connected to processor 230.

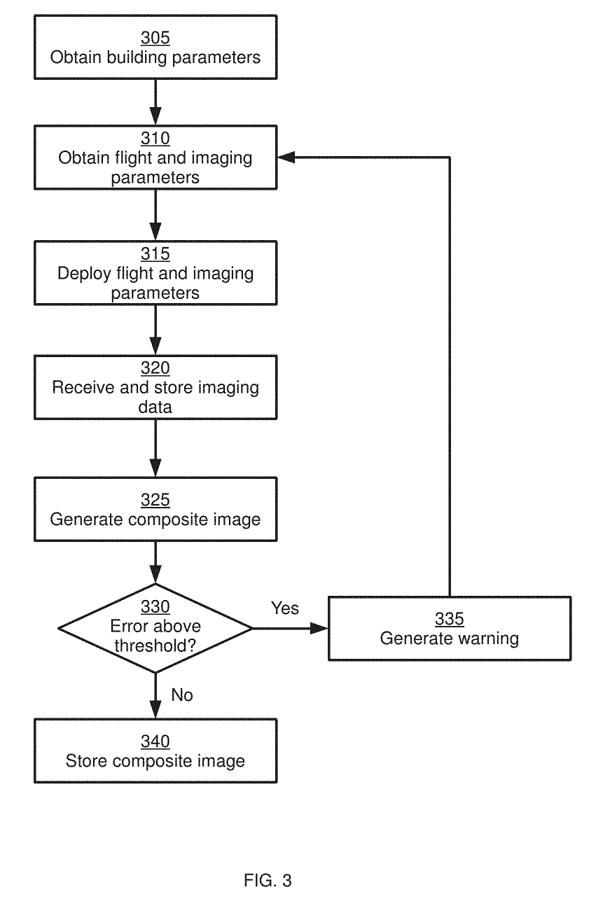

Turning now to FIG. 3, a method 300 of generating a building map is depicted. Method 300 will be described below in conjunction with its performance in system 100, as deployed to map building 104. More specifically, the blocks of method 300 are performed by computing device 124, via the execution of control application 238. It is contemplated, however, that method 300 can also be performed on variations of system 100.

Beginning at block 305, computing device 124 is configured to obtain building parameters. The building parameters, in general, establish a boundary of the face (or multiple faces) of building 104 to be mapped during the performance of method 300, according to a frame of reference. In the present example performance of method 300, it will be assumed that unmanned aerial vehicle 116 is to map roof 108 of building 104. Therefore, at block 305 building parameters are obtained by computing device 124 that define the extent of roof 108 of building 104 according to a frame of reference.

The frame of reference can be based on a global coordinate system, and the building parameters obtained by computing device 124 at block 305 can therefore include global positioning system (GPS) coordinates for each of the four corners of roof 108, or any other suitable boundaries for roof 108. The receipt of building parameters by computing device 124 can also define a geofence for vehicle 116, according to techniques that will readily occur to the skilled person.

The building parameters can be obtained by computing device 124 at block 305 by, for example, receiving the building parameters as input data from keyboard 254 or from another computing device via network interface 250. In some embodiments, computing device 124 can be configured to retrieve the building parameters automatically. For example, computing device 124 can receive (e.g. via keyboard 254) an address or other location indicator for building 104, and retrieve a profile or boundary for building 104 by querying a geographic data service via network interface 250.

Having obtained building parameters 305, at block 310 computing device 124 is configured to obtain flight parameters for unmanned aerial vehicle 116 and imaging parameters for unmanned aerial vehicle 116. In general, the flight parameters define a flight path to be executed by unmanned aerial vehicle 116, and the imaging parameters define a plurality of image capture operations to be performed by unmanned aerial vehicle 116 during the execution of the above-mentioned flight path.

The flight path defined by the flight parameters can take a variety of forms. For example, the flight path can include a sequence of coordinate sets each identifying a location in the frame of reference discussed above. In other examples, the flight path can include a plurality of vectors, each including a distance and a direction (e.g. relative to the origin of the above-mentioned frame of reference). The flight path can also include velocity commands associated with each coordinate set or vector, indicating the speed at which unmanned vehicle 116 is to travel between coordinate sets or along vectors.

Computing device 124 can obtain the flight parameters by receiving input data, for example from keyboard 254. More specifically, computing device 124 can be configured to present, on display 258, an interface depicting the above-mentioned building parameters. Responsive to presenting the interface, processor 230 can receive input data from keyboard 254 and any other input devices (e.g. a mouse) connected to processor 230 defining a plurality of flight path segments, either in the form of coordinate sets or vectors.

Imaging parameters obtained by computing device 124 at block 310 define at least a number of images of building 104 to be captured. The number of image captures can be defined by a plurality of locations within the above-mentioned frame of reference, by times relative to the beginning of the execution of the flight path, by one or more frequencies of image capture during the execution of the flight path, and the like. The imaging parameters can also include control parameters for imaging device 120, such as focal length, aperture size, sensitivity and the like.

As with the flight parameters, computing device 124 can obtain flight parameters at block 310 by receiving the flight parameters as input data from an input device such as keyboard 254. In such embodiments, the imaging parameters may be selected by an operator of computing device 124. In other embodiments, computing device 124 can automatically select the imaging parameters. Indeed, in some examples computing device 124 can be configured to first select the imaging parameters, based on the building parameters and known (e.g. stored in memory 234 or retrieved from unmanned aerial vehicle 116) operational characteristics of imaging device 120. For example, computing device 124 can maintain in memory 234 a preconfigured target level of detail (e.g. one pixel per 2×2 cm area of building 104). Based on the target level of detail, the known sensor resolution and viewing angle of imaging device 120, computing device 124 can be configured to subdivide the boundary of the area to be mapped (as defined by the building parameters) into a plurality of target image areas. Computing device 124 can be configured to select target image areas having boundaries that overlap by a preconfigured amount, to aid in image capture and composite generation, discussed below. Computing device 124 can then be configured to generate flight path data by generating a plurality of flight path segments that connect the target image areas (e.g. the center of each target image area) in sequence.

In some embodiments, computing device 124 can be configured to automatically generate flight and imaging parameters by retrieving intermediate flight and imaging parameters from memory 234 based on supplemental building parameters received as input data at block 305. Specifically, the building parameters obtained at block 305 can include such supplemental parameters as a building surface material (e.g. the material covering roof 108), a number of items (e.g. heating, ventilation and air conditioning (HVAC) units, maintenance huts and the like) on roof 108, and the type of items (e.g. a certain number of HVAC units, a further number of exhaust vents, and the like) present on roof 108. Responsive to receiving the supplemental building parameters, computing device 124 can retrieve from memory a set of corresponding intermediate flight and imaging parameters.

The intermediate parameters retrieved by computing device 124 include a distance from the surface to be mapped (i.e. an altitude above roof 108, or a horizontal distance from wall 112), a speed of travel for vehicle 116, a fraction (e.g. a percentage) of overlap for the front of each image captured by vehicle 116 with the next image captured by vehicle 116, and a fraction (e.g. percentage) of overlap for the sides of each image captured by vehicle 116 with images capture earlier or later in the flight of adjacent portions of building 104.

The intermediate parameters can be stored in a variety of ways in memory 234. For example, memory 234 can store a matrix, with each cell corresponding to a particular pair of material type and item count. The cell can contain the corresponding intermediate parameters. Higher dimensional matrices can be employed to store intermediate parameters for combinations of three or more supplemental building parameters (e.g. adding the type of items to the above). Further data can be employed to look up intermediate parameters, including environmental conditions (e.g. temperature, wind speed) and imaging device attributes such as field of view.

Having retrieved the intermediate parameters, computing device 124 can automatically generate the final flight parameters (i.e. those defining the grid to be travelled by vehicle 116) according to any suitable conventional techniques.

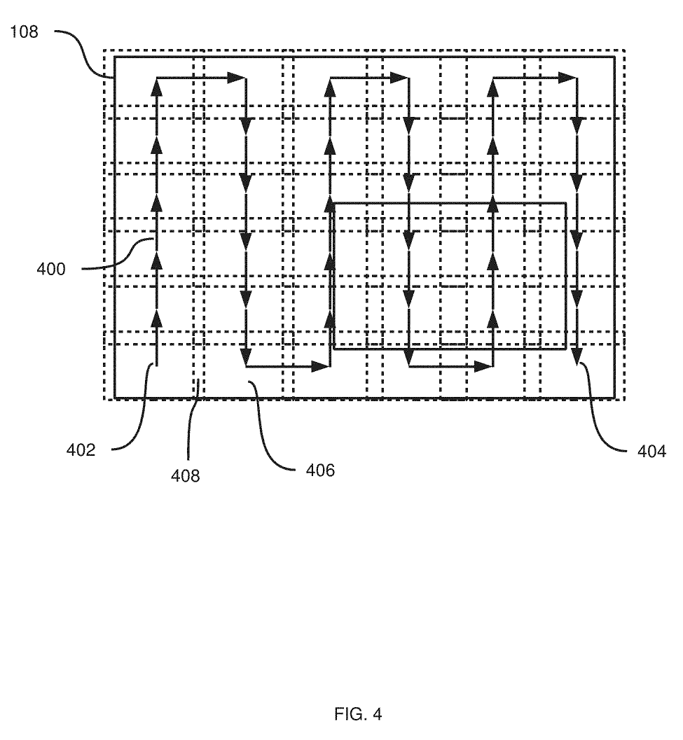

Turning to FIG. 4, a plan view of roof 108 is shown, with visual representations of the data obtained by computing device 124 (either generated automatically or received as input data) at block 310. In particular, the flight path parameters define a plurality of flight path segments 400 (illustrated as arrows in FIG. 4), connected in sequence to form a flight path travelling from a start 402 to an end 404. The imaging parameters define a plurality image target areas 406 each covering a portion of roof 108 (more particularly, a portion of the area bounded by the building parameters obtained at block 305). Image target areas 406 are illustrated as partially overlapping, as indicated by overlap areas 408. As also seen in FIG. 4, each segment 400 of the flight path connects the centers of two adjacent target image areas 406. Although not illustrated in FIG. 4, each flight segment 400 also defines a height of travel for unmanned aerial vehicle 116 (that is, an elevation, perpendicular to the two dimensions shown in FIG. 4). The elevation can be selected, for example, based on the building parameters, to ensure that unmanned aerial vehicle 116 maintains at least a predefined clearance above roof 108 during the execution of the flight path.

In this embodiment, the imaging parameters can include instructions to capture an image at the termination of each segment 400. As will now be apparent to those skilled in the art, the flight and imaging parameters can be structured in a variety of other ways than those shown in FIG. 4. For example, in some embodiments, the flight path parameters can include a smaller number of segments, and the imaging parameters can include instructions to capture images at certain locations (defined according to the above-mentioned frame of reference) along the length of the segments, rather than at the ends of the segments.

Although the examples above assume that a single unmanned aerial vehicle 116 is employed in system 100, in other embodiments a plurality of unmanned aerial vehicles 116 can be deployed. In such embodiments, the performance of block 310 is repeated for each unmanned aerial vehicle 116. In general, the mapping boundary defined by the building parameters received at block 305 can be divided into a plurality of regions each corresponding to one unmanned aerial vehicle 116. The performance of block 310 can then be repeated for each region.

Returning to FIG. 3, responsive to obtaining flight parameters and imaging parameters, at block 320 computing device 124 is configured to deploy the flight and imaging parameters to unmanned aerial vehicle 116. The deployment of flight and imaging parameters can be performed in a variety of ways. In some embodiments, computing device 124 transmits all flight and imaging parameters obtained at block 310 to unmanned aerial vehicle 116 via network interface 250, for receipt at unmanned aerial vehicle 116 via network interface 220 and storage in memory 204. In other embodiments, computing device 124 is configured to transmit sequential portions of the flight and imaging parameters to unmanned aerial vehicle 116. For example, computing device 124 can be configured to transmit the flight and imaging parameters defining the first segment 400 and the first image capture (that is, the first target image area) shown in FIG. 4 to unmanned aerial vehicle 116. Responsive to receiving confirmation from unmanned aerial vehicle 116 that the first portion of the flight path has been executed, computing device 124 can transmit the next portion.

In still other embodiments, block 315 can include receiving input data at computing device 124 (e.g. via keyboard 254 or any other suitable input device) representing operator commands, and transmit the operator commands to unmanned aerial vehicle 116. During the receipt of operator commands, computing device 124 can present on display 258 the flight path and imaging parameters such as those shown in FIG. 4, along with a current location of unmanned aerial vehicle 116 superimposed on the flight path and imaging parameters. In other words, in such embodiments, the flight path and imaging parameters can be deployed by computing device 124 to guide an operator of computing device 124.

Unmanned aerial vehicle 116, in response to receiving at least a portion of the flight path and imaging parameters, is configured to execute the flight path and capture a plurality of images using imaging device 120, according to the flight path and imaging parameters. More specifically, processor 200 is configured to execute application 208 in order to control the other components of unmanned aerial vehicle 116, including motor 216, to travel along the flight path received from computing device 124 and capture images according to the image parameters received from computing device 124. Unmanned aerial vehicle 116 is configured to execute the flight path based on the flight path parameters and the current position.

In some embodiments, unmanned aerial vehicle 116 can also be configured to obtain measurements of environmental conditions, such as wind speed, and apply such environmental conditions as feedback to the execution of the flight path.

At block 320, responsive to the deployment of flight path and imaging parameters, computing device 124 is configured to receive image data from unmanned aerial vehicle 116. The receipt of image data can occur after all flight and imaging parameters have been deployed, or during the deployment of flight and imaging parameters. In other words, unmanned aerial vehicle 116 can be configured to either transmit image data during the execution of the flight path, or to store all image data in memory 204 for transmission to computing device 124 after completion of flight path execution.

In the present embodiment, the image data received at block 320 includes an image corresponding to each of the target image areas defined by the imaging parameters obtained at block 310 and deployed at block 315. Thus, following the example shown in FIG. 4, a total of thirty-six images are received at block 320, corresponding to the thirty-six target image areas 406 shown in FIG. 4. Computing device 124 is configured to store the received image data in memory 234 for further processing.

In other embodiments, the image data received at block 320 can include a video file or stream consisting of a plurality of image frames, rather than a plurality of discrete image files.

At block 325, computing device 124 is configured to generate a single composite image from the image data received at block 320. The composite image is generated by executing any suitable image registration process, to transform each pixel of each received image from an image-specific coordinate system into a composite image coordinate system. Examples of image registration techniques that can be applied by computing device 124 include feature-based registration (e.g. detecting and matching points, lines and the like in adjacent images), intensity-based registration (e.g. detecting and matching areas of colour, contrast and the like in adjacent images). Based on the overlap specified previously in the imaging parameters, computing device 124 can be configured to limit the area of each image to be searched for features matching those of an adjacent image to only a portion of the image, thus reducing the computational burden of generating the composite image. In addition, computing device 124 can reduce the set of images to inspect for features matching the features of a given image, based on the predetermined locations from which the images were captured. For example, an image captured at the final segment 400 of the flight path shown in FIG. 4 does not overlap the image captured at the first segment 400 of the flight path, and computing device 124 can therefore be configured to ignore the final image when searching for features matching those of the first image. This process can further reduce the computational burden of image registration at computing device 124.

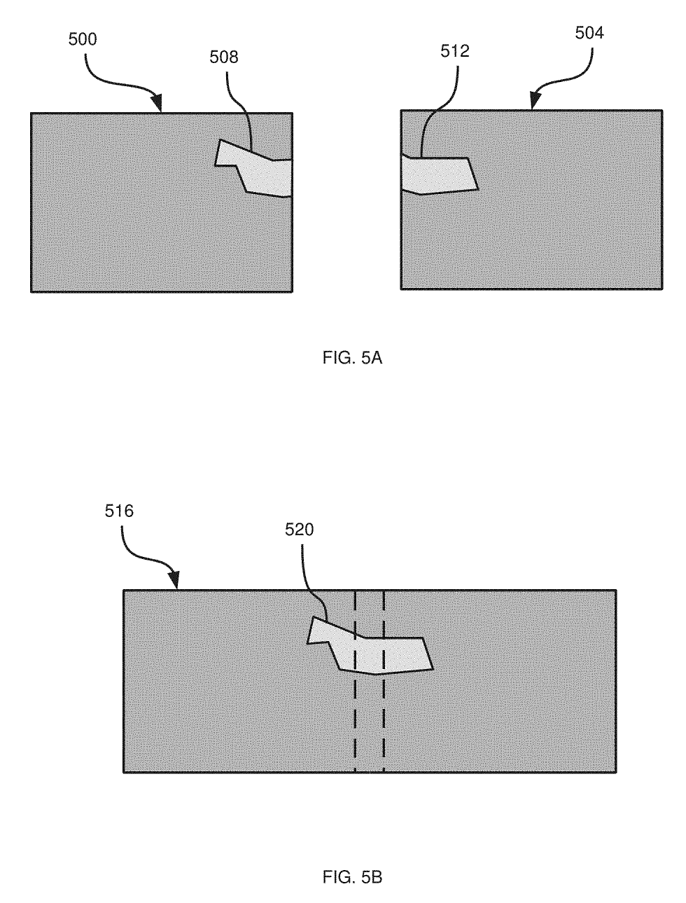

FIG. 5A depicts two example images 500 and 504 received at block 320. Based on the locations at which images 500 and 504 were captured (which may be embedded in the image files, or determined by computing device by comparing the order in which images 500 and 504 were received to the flight path and imaging parameters described earlier), computing device 124 has determined that images 500 and 504 are likely to depict overlapping portions of building 104. Applying any suitable image registration techniques, computing device 124 can identify, for example, an image feature such as region 508 in image 500 and region 512 in image 504 as matching each other. Following the identification of regions 508 and 512, computing device 124 combines images 500 and 504 to generate a composite image 516, shown in FIG. 5B. As seen in FIG. 5B, composite image 516 includes a feature 520 containing both the regions 508 and 512. The original boundaries of images 500 and 504 are depicted in dotted lines on image 516, although such boundaries are not stored in image 516. The above process is repeated by computing device 124 until all images received at block 320 have been integrated into the composite image.

At block 330, responsive to generating the composite image, computing device 124 is configured to determine whether an error metric associated with the generation of the composite image is above a preconfigured threshold. Any suitable error metric can be employed at block 330; such metrics generally reflect the degree of similarity between images determined to be overlapping during composite image generation. In other words, the error metric is an indication of match quality or confidence.

If the error metric is above the preconfigured threshold, the performance of method 300 proceeds to block 335, at which computing device 124 can be configured to generate a warning, such as a message presented on display 258 advising an operator that the composite image generated at block 325 is of insufficient quality. Computing device 124 can then return to block 310 to generate further flight and imaging parameters. The composite image generated at block 325 can be discarded following a negative determination at block 330 in some (though not necessarily all) embodiments.

When the determination at block 330 is negative (that is, when the error metric does not exceed the preconfigured threshold), the performance of method 300 proceeds to block 340. At block 340, computing device 124 is configured to store the composite image in memory 234. Computing device 124 can also be configured to control display 258 to present the composite image.

In some embodiments, blocks 330 and 335 can be omitted from method 300. In such embodiments, computing device 124 proceeds from block 325 directly to block 340, without performing an assessment of composite image quality.

Variations to the above embodiments are contemplated. For example, in some embodiments computing device 124 can be configured to repeat the performance of method 300 for each of a plurality of faces of a building (e.g. roof 108 and each wall of building 104). Following the generation of a composite image for each building face, computing device 124 can be configured to generate a further composite image depicted every building face. Such a composite image can be provided in two dimensions (e.g. an “unfolded” image of the building), or in three dimensions.

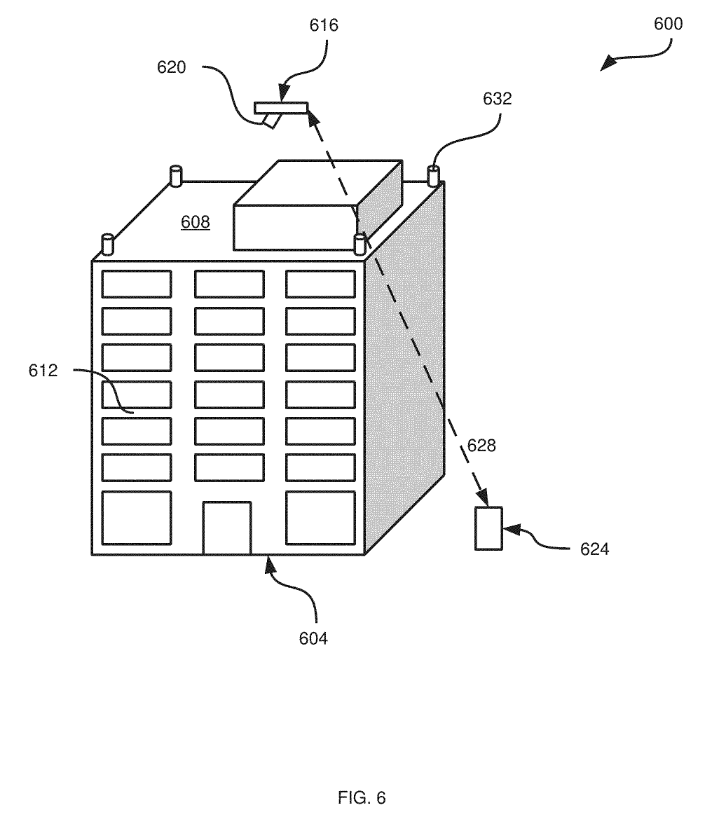

Referring now to FIG. 6, a further variation is illustrated as a system 600. Elements of system 600 that are numbered similarly to those of system 100 but with a leading ‘6’ instead of a leading ‘1’—a building 604 with a roof 608 and walls 612, an aerial vehicle 616 carrying an imaging device 620, a computing device 624 and a communications link 628 —are as described above. It will now be apparent that a repeater is omitted from system 600; in other embodiments, however, a repeater similar to repeater 130 can be included in system 600.

System 600 can also include at least one beacon 632 (four beacons 632 are shown in FIG. 6, although any suitable number of beacons can be employed for a given building, as will be apparent in the discussion below) for placement on building 608. Beacons 632 can be employed to facilitate the control of unmanned autonomous vehicle 616.

When performing method 300 in system 600, the performance of block 305 can be preceded by deploying (e.g. by an operator of computing device 624) any suitable number of beacons 632 on roof 608. Preferably, at least four beacons are deployed on roof 608 (or any other face of building 604 being mapped), to allow for location of unmanned aerial vehicle 616 in three dimensions (e.g. via trilateration).

The building parameters obtained at block 305 can include GPS coordinates of beacons 632. In other implementations, instead of the GPS coordinates of beacons 632, the building parameters can include vectors (e.g. distance and direction) defining the positions of each beacon 632 relative to a beacon 632 selected as an origin. In other words, beacons 632 can define a local frame of reference (e.g. a three-dimensional Cartesian coordinate system centered on one of the beacons 632), thus reducing or eliminating the need to retrieve GPS coordinates for building 604. That is, beacons 632 can supplement or replace the use of the geofencing techniques mentioned above.

Unmanned aerial vehicle 616 can be configured to receive beacon signals from each beacon 632, and to determine (e.g. via trilateration based on signal strengths from each beacon) its current position relative to beacons 632. Unmanned aerial vehicle 616 is configured to execute the flight path based on the flight path parameters (which may specify locations in the frame of reference defined by beacons 632) and the current position.

In addition, those skilled in the art will appreciate that in some embodiments, the functionality of processor 200 and application 208, as well as the functionality of processor 230 and application 238, can be implemented using pre-programmed hardware or firmware elements (e.g., application specific integrated circuits (ASICs), electrically erasable programmable read-only memories (EEPROMs), etc.), or other related components. Other variations to the above may also occur to those skilled in the art.

The scope of the claims should not be limited by the embodiments set forth in the above examples, but should be given the broadest interpretation consistent with the description as a whole.

We claim:

1. A system for generating a map for a building, comprising:
an unmanned aerial vehicle carrying at least one imaging device;
a computing device connected to the unmanned aerial vehicle, the computing device configured to:
obtain building parameters defining a portion of the building to be mapped according to a frame of reference;
obtain flight parameters defining a flight path for the unmanned aerial vehicle;
obtain imaging parameters defining a plurality of image capture operations for the imaging device of the unmanned aerial vehicle;
deploy the flight path parameters and the imaging parameters to the unmanned aerial vehicle;
responsive to deploying the flight path parameters and the imaging parameters, receive a plurality of images from the unmanned aerial vehicle, the plurality of images captured by the unmanned aerial vehicle according to the imaging parameters;
generate a composite image from the plurality of images; and
store the composite image in a memory.

2. The system of claim 1, the computing device configured to obtain flight parameters defining a plurality of segments of a flight path according to the frame of reference.

3. The system of claim 1, further comprising:
a plurality of beacons disposed in proximity with the building; each beacon configured to emit a signal for detection by the unmanned aerial vehicle;
the computing device further configured to receive relative positions of the beacons, and to define the frame of reference based on the relative positions.

4. The system of claim 3, the unmanned aerial vehicle configured to receive the signals emitted by at least a subset of the beacons, and to determine a current position of the unmanned aerial vehicle within the frame of reference based on the received signals.

5. The system of claim 1, the imaging device comprising at least one of an infrared camera, an optical camera, and a lidar sensor.

6. The system of claim 1, the computing device further configured to present the composite image on a display.

7. The system of claim 1, the imaging parameters defining a plurality of target image areas according to the frame of reference.

8. The system of claim 1, adjacent pairs of the plurality of target image areas having overlapping regions.

9. The system of claim 8, the computing device further configured to generate the composite image by:
selecting a pair of the plurality of received images corresponding to an adjacent pair of the target image areas;
selecting a portion of each of the pair of selected images; and
identifying common features between the selected portions.

10. The system of claim 9, the computing device further configured to select the portion of each of the pair of selected images based on the overlapping regions.

11. The system of claim 1, further comprising;
a plurality of unmanned aerial vehicles;
the computing device further configured to repeat the generation of flight parameters and imaging parameters for each of the plurality of unmanned aerial vehicles.

12. The system of claim 1, the computing device further configured to:
responsive to generating the composite image, determine whether an error metric associated with the composite image exceeds a predetermined threshold;
if the determination is affirmative, discard the composite image; and
otherwise, store the composite image.

13. A method of generating a map for a building with an unmanned aerial vehicle carrying at least one imaging device, the method comprising:
obtaining, at a computing device connected to the unmanned aerial vehicle, building parameters defining a portion of the building to be mapped according to a frame of reference;
obtaining, at the computing device, flight parameters defining a flight path for the unmanned aerial vehicle;
obtaining, at the computing device, imaging parameters defining a plurality of image capture operations for the imaging device of the unmanned aerial vehicle;
deploying the flight path parameters and the imaging parameters from the computing device to the unmanned aerial vehicle;
responsive to deploying the flight path parameters and the imaging parameters, receiving a plurality of images at the computing device from the unmanned aerial vehicle, the plurality of images captured by the unmanned aerial vehicle according to the imaging parameters;
generating a composite image from the plurality of images; and storing the composite image in a memory of the computing device.

14. The method of claim 13, the flight parameters defining a plurality of segments of a flight path according to the frame of reference.

15. The method of claim 13, further comprising: presenting the composite image on a display.

16. The method of claim 13, the imaging parameters defining a plurality of target image areas according to the frame of reference.

17. The method of claim 13, adjacent pairs of the plurality of target image areas having overlapping regions.

18. The method of claim 17, further comprising generating the composite image by:
selecting a pair of the plurality of received images corresponding to an adjacent pair of the target image areas;
selecting a portion of each of the pair of selected images; and
identifying common features between the selected portions.

19. The method of claim 18, further comprising: selecting the portion of each of the pair of selected images based on the overlapping regions.

20. The method of claim 13, further comprising:
responsive to generating the composite image, determining whether an error metric associated with the composite image exceeds a predetermined threshold;
if the determination is affirmative, discarding the composite image; and
otherwise, storing the composite image.
